(19) United States
(12) Patent Application Publication
(10) Pub. No.: US 2007/0060387 A1
(43) Pub. Date: Mar. 15, 2007

(54) GAMING FLOOR CONTROL AND CONFIGURATION SYSTEM

(76) Inventors: Joseph R. Enzminger, Austin, TX (US); David C. Martin, Austin, TX (US); Clifton E. Lind, Austin, TX (US); Jefferson C. Lind, Austin, TX (US); Brendan M. O'Connor, Austin, TX (US); P. Howard Chalmers JR., Austin, TX (US); Troy W. Jungmann, Austin, TX (US); Nimai C. Malle, Austin, TX (US)

Correspondence Address: THE CULBERTSON GROUP, P.C., 1114 LOST CREEK BLVD., SUITE 420, AUSTIN, TX, 78746, US

(21) Appl. No.: 11/531,206

(22) Filed: Sep. 12, 2006

Related U.S. Application Data
(60) Provisional application No. 60/716,796, filed on Sep. 13, 2005.
(60) Provisional application No. 60/723,730, filed on Oct. 5, 2005.

(51) Int. Cl. A63F 13/00

(52) U.S. Cl. 463/43

(57) ABSTRACT

A method includes periodically over a given day comparing an actual status for a casino player station with a current target status for the casino player station. The actual status for the casino player station specifies an actual game presentation operating at the casino player station at the particular time. A modification command is issued to the casino player station in the event that the current target status for the casino player station does not match the actual status for the casino player station. In response to the modification command, a target game presentation is launched at the casino player station. This target game presentation is specified by the current target status for the casino player station and is different from the actual game presentation specified by the actual status for the casino player station. The method thus facilitates configuration changes in the various player stations in a gaming system to ensure the desired game presentations are available to players.

### CROSS-REFERENCE TO RELATED APPLICATIONS

The Applicants claim the benefit, under 35 U.S.C. § 119(e), of U.S. Provisional Patent Application No. 60/716,796 filed Sep. 13, 2005, and entitled “GAMING FLOOR CONTROL AND CONFIGURATION SYSTEM,” and of U.S. Provisional Patent Application No. 60/723,730 filed Oct. 5, 2005, and entitled “GAMING FLOOR CONTROL AND CONFIGURATION SYSTEM.” The entire content of each or these provisional applications is incorporated herein by this reference.

### TECHNICAL FIELD OF THE INVENTION

The present invention relates to casino management systems. In particular, the invention is directed to a casino management system that facilitates rapid changes in casino floor configuration and casino floor optimization. The invention encompasses casino floor management methods, apparatus, and program products.

### BACKGROUND OF THE INVENTION

U.S. patent publication No. 2004-0229698-A1 discloses gaming systems that employ configurable player stations that can be reconfigured remotely to provide any one of a number of game presentations. The gaming systems disclosed in patent application publication 2004-0229698-A1 may use actual player preference information and/or projected player preference information to configure the various player stations in a casino in an effort to offer the most desirable game presentations to the various players in the casino, and to help enhance the player's gaming experience in the casino.

As used in the above-referenced patent application and in this document, the designation “game presentation” refers to the look of a particular game to a player at a player station. The game presentation includes the animated graphics displayed on the video display devices associated with the player station. For example, a game presentation may include a series of simulated reels to simulate the operation of a mechanical slot machine, the paytables and other information typically included in an area of the player station above the simulated reels, the arrangement of player controls typically located at a player station immediately below the simulated reels, and the theme graphics and information typically included below the arrangement of player controls. As another example, a game presentation may include graphics associated with a simulated card game, or other casino game. Still other game presentations may include graphics depicting various types of games, horse or dog races, and various other simulated competitions.

### SUMMARY OF THE INVENTION

The present invention provides a method for controlling the modification of the game presentations provided at the various player stations including in a gaming system having configurable player stations such as the player stations described in U.S. patent publication No. 2004-0229698-A1. Methods according to the invention facilitate automated modification of player station game content and optimization of game presentations available in a given casino. The present invention also includes apparatus and program products for controlling the modification of game presentations available in a gaming system having configurable player stations.

One preferred method embodying the principles of the invention includes periodically over a given day comparing an actual status for a casino player station with a current target status for the casino player station, where the actual status specifies an actual game presentation operating at the casino player station at the particular time. This preferred method then includes issuing a modification command to the casino player station in the event that the current target status for the casino player station does not match the actual status for the casino player station. In response to the modification command, a target game presentation is launched at the casino player station. This target game presentation is specified by the current target status for the casino player station and is different from the actual game presentation specified by the actual status for the casino player station. The method thus facilitates configuration changes in the various player stations in a gaming system to ensure the desired game presentations are available to the players.

One preferred apparatus for controlling the game presentations available at the player stations of a gaming system includes. A profile controller and a client launcher controller. The profile controller periodically over a given day compares an actual status for a first player station with a current target status for the first player station, and, in the event the current target status does not match the actual status, for issues a modification command to the first player station. The actual status for the first player station specifies an actual game presentation operating at the first player station while the current target status for the first player station specifies a target game presentation that may or may not be different from the actual game presentation operating at the player station. The client launcher controller is preferably implemented at the first player station and causes the first player station to launch the target game presentation in response to the modification command.

In one preferred form of the invention the profile controller and client launcher controller are each implemented through a respective general purpose processing device operating under the control of operational programs. In this implementation, the invention further includes a program product embodied in one or more computer readable media, and being executable for performing the various method steps and functions described above. In particular, a program product according to the invention may include profile controller program code that is executable for performing the functions of the profile controller, and may also include client launcher controller program code that is executed to perform the functions of the client launcher controller.

### BRIEF DESCRIPTION OF THE DRAWINGS

FIG. 1 is a view in perspective of a player station that may be used in a gaming system embodying the principles of the invention.

FIG. 2 is a schematic diagram showing the various components of one preferred form of player station that may be used according to the present invention.

FIG. 3 is a high level schematic diagram showing a gaming system embodying the principles of the present invention.

FIG. 4 is a diagrammatic representation showing the various controllers implemented through the hardware components shown in FIG. 3.

FIG. 5 is a flow chart illustrating a method of controlling the modification of configurable player stations according to the present invention.

### DESCRIPTION OF ILLUSTRATIVE EMBODIMENTS

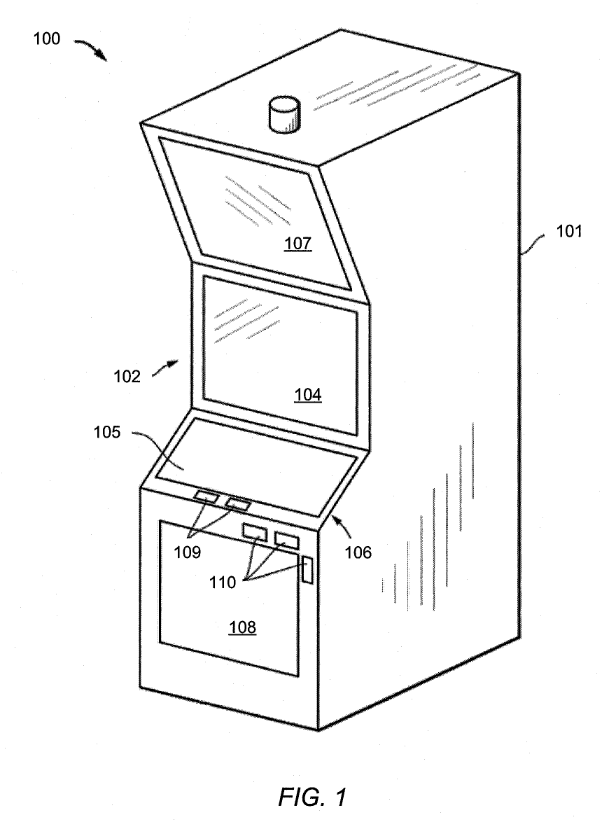

Referring to FIG. 1, a player station 100 includes a cabinet 101 having a front side generally shown at reference numeral 102. A game video display 104 is mounted in a central portion of the front surface 102 with a player control ledge 106 positioned below the game video display and projecting forwardly from the plane of the game video display. In addition to the game video display 104, the illustrated form of the invention includes a first additional video display 107 positioned on the front side of cabinet 101 above game video display 104, and a second additional video display 108 mounted on the front side of the cabinet below the game video display. Each of these displays, the game video display 104, first additional video display 107, and second additional video display 108 participate in the operation of player station 100 to provide a presentation for a particular game or potentially, presentations for multiple games simultaneously. It is noted that player station 100 is shown in an operating position in FIG. 1 and the descriptions of positions above or below certain elements are made with reference to this illustrated operating position.

Player station 100 illustrated in FIG. 1 includes a player control touch screen display 105 that forms a portion of player control ledge 106 extending transversely to the plane of game video display 104. With this separate player control touch screen 105, the illustrated player station 100 includes a total of four different video displays that together provide the game presentation or presentations in the course of operation of the player station. In addition to the separate player control touch screen 105, player station 100 also includes mechanical player control buttons or other input devices 109 mounted on player control ledge 106. Other forms of the invention may include switches, joysticks, or other player input devices mounted on player control ledge 106. However, all of the traditional player control inputs from devices such as switches, buttons, and pointer controls, can be provided through the illustrated touch screen display/player control device 105 and/or touch screen elements incorporated with the other video displays 104, 107, and 108 included in player station 100. Using the separate player control touch screen display 105 in player station 100 allows the player controls to be modified readily from one game presentation to the next and even within a single presentation.

It will be appreciated that player stations may also include player interface devices in addition to devices that are considered player controls for use in playing a particular game. For example, player stations commonly include a player card reader, a voucher or ticket reader/issuer, a currency acceptor/validator, and/or coin or token acceptors/dispensers. The form of the invention shown in FIG. 1 includes these types of additional player interface devices 110 on a lower portion of the cabinet 101 generally in the plane of the lower or second additional video display 108.

Although FIG. 1 shows four separate video displays that combine to produce the game presentation or presentations for player station 100, it will be appreciated that fewer video displays may be used. For example, a player station according to the invention may include game video display 104 and only a single additional video display that may be mounted above or below the game video display and take up the entire area of the player station front surface previously reserved for a static top glass or belly glass display. Also, although each video display shown in FIG. 1 is indicated as being a single display, it will be appreciated that each video display 104, 105, 107, and 108 shown in FIG. 1 may in fact be made up of two or more separate displays that combine to provide what appears to the user to be a single display. It will also be appreciated that many different types of video displays may be used for the displays in the present invention including cathode ray tubes, liquid crystal displays, plasma displays, LED displays or any other type of video display device currently known or that may be developed in the future.

The invention is not limited to any particular uses of the displays 104, 105, 107, and 108 in a given presentation. For example, only one display among the several displays included in player station 100 may be used in the actual conduct of a game, while the remaining displays may simply show attractive graphics. In other arrangements each display may actually provide a presentation for a different game. One or more of the displays 104, 105, 107, and 108 may be used to provide other graphic content to the player unrelated to gaming, such as television programming or movies. In yet other implementations, a portion of one or more displays 104, 105, 107, or 108 may be devoted to graphics associated with one presentation while another portion of the same display may be devoted to graphics for another game presentation. For example, a player station 100 may be controlled such that a right-hand side of the machine shows one game presentation while a left-hand side of the machine shows a second different game presentation. It should also be noted that one or more progressive meters may be shown on the various displays in player station 100, or one or more separate progressive meters/displays may be included in player station 100.

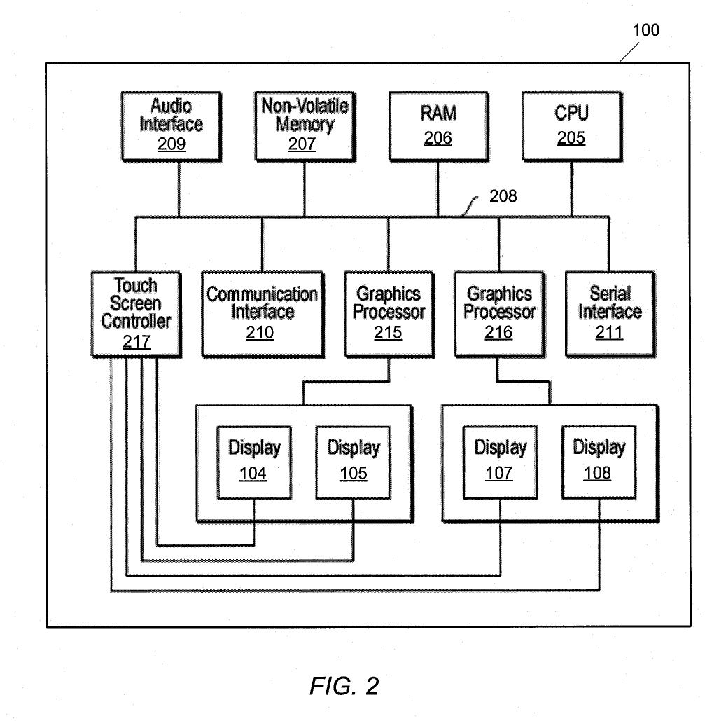

FIG. 2 provides a block diagram showing all the components of player station 100 (shown in FIG. 1) including the displays 104, 105, 107, and 108. Player station 100 includes a central processing unit (CPU) 205 along with random access memory 206 and nonvolatile memory or storage device 207. All of these devices are connected on a common system bus 208 with an audio interface device 209, communications interface 210, and a serial interface 211. Two graphics processors 215 and 216 are also connected on the common bus 208 and are connected to drive the displays mounted on cabinet 101 (shown in FIG. 1). Graphics processor 215 controls game video display 104 and player control display 105 while graphics processor 216 controls first additional display 107 and second additional display 108. The system shown in FIG. 2 also includes a touch screen controller 217 connected to system bus 208. Touch screen controller 217 is also connected to receive signals from touch screen elements associated with each display, 104, 105, 107, and 108. It will be appreciated that the touch screen elements themselves comprise thin films that are secured over the respective video display. These touch screen elements are not illustrated or referenced separately in the figures. It will also be appreciated that touch screen elements may not be associated with each display, although most preferred forms of player stations according to the present invention will have a touch screen element associated with at least game video display 104 and player control video display 105.

All of the elements 205, 206, 207, 208, 209, 210, and 211 shown in FIG. 2 are elements commonly associated with a personal computer. These elements are preferably mounted on a standard personal computer chassis and housed in a standard personal computer housing which is itself mounted in cabinet 101 shown in FIG. 1. Alternatively, the various processing elements may be mounted on one or more circuit boards mounted within cabinet 101 without a separate enclosure such as those found in personal computers. Those familiar with data processing systems and the various data processing elements shown in FIG. 2 will appreciate that many variations on this illustrated structure may be used within the scope of the present invention. For example, serial communications are commonly employed between a touch screen controller and a host computer system. Thus, a player station according to the invention may have the touch screen controller 217 connected to the host computer system through a suitable serial interface such as serial interface 211, which may be a USB controller or a IEEE 1394 controller. It will also be noted that many of the devices shown connected to system bus 208 in FIG. 2 may require an interface to the system bus. For example, audio interface device 209 may be connected directly to an expansion bus such as a PCI bus. Numerous other variations in the player station's internal structure and system may be used in accordance with the principles of the present invention.

It will also be appreciated that graphics processors are also commonly a part of modern computer systems. Although two separate graphics processors 215 and 216 are shown for controlling the four displays included in this form of the invention, it will be appreciated that a separate graphics processor may be included in the system for each particular display. It is also possible for a single graphics processor to control all of the video displays mounted on player station 100. Generally, the invention is not limited to any particular arrangement of graphics processors for controlling the various player station displays.

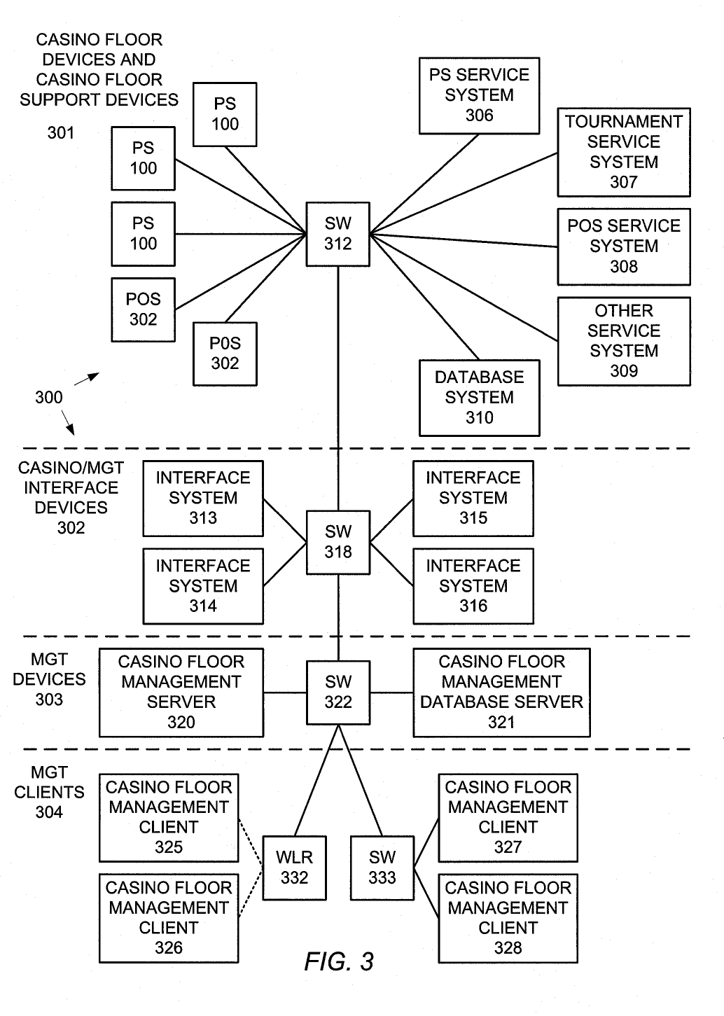

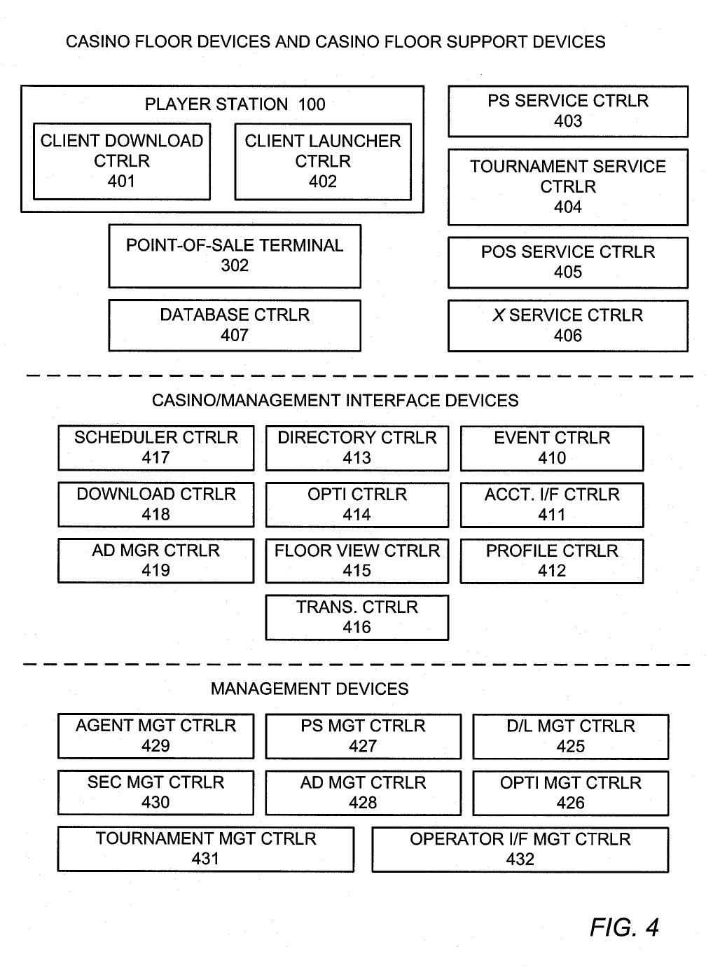

In the illustrated player station 100, CPU 205 executes game software which ultimately controls the entire player station 100 including the presentation provided through the video displays. CPU 205 also executes software related to communications handled through communications interface 210, and software related to various peripheral devices such as those connected to the system through audio interface 209 and serial interface 211. CPU 205 may also execute software to perform accounting functions associated with game play. Random access memory 206 provides memory for use by the CPU 205 in executing its various software programs while the nonvolatile memory or mass storage 207 provides storage for programs not in use or for other data generated or used in the course of player station operation. Communications interface 210 provides an interface to other components of a gaming system that may be involved in game play. For example, some player stations rely on remote processing units for providing accounting functions associated with game play and also for providing game results. U.S. Pat. No. 6,524,184 provides an example of a gaming system which includes player terminals and remote systems for providing results from predetermined game play records stored at the remote systems. Even where the results of game play are determined at the player station itself, player stations are commonly interfaced with systems for accounting purposes and control purposes, and communications interface 210 may also provide an interface for such communications. Communications interface 210 also provides an interface to a remote device that controls presentation changes at the player station as will be described below with reference to FIGS. 3 and 4.

Audio interface 209 provides an interface for an audio system that may be included in player station 100. Serial interface 211 provides an interface for serial devices such as player controls not incorporated in any touch screen display, and possibly the touch screen elements themselves, and other player interface devices such as currency acceptors/validators, a player card reader, voucher readers/printers, and coin/token drops. Serial interface 211 may also provide an interface with various meters that may be included in player station 100 such as a progressive meter, for example. Commonly, a single serial interface device is used to communicate with a number of serial devices through a suitable serial protocol such as USB or IEEE 1394. However, it will be appreciated that additional serial interfaces may be used depending upon the nature of the serial protocols used for communications and the number of serial devices included in player station 100.

It will be appreciated that other basic components will be included in player station 100 such as a power supply, cooling systems for the various processors, audio amplifiers and speakers, and other devices that are common in player stations. These additional devices are omitted from the drawings so as not to obscure the present invention in unnecessary detail.

It should also be noted that the data processing required to operate the various displays and other components of player station 100 may be distributed to data processing devices outside of the player station itself. For example, player station 100 may rely on data processing and control from a central computer system in communication with the player station or various elements of the player station. The example shown in FIG. 2 should be seen as merely one implementation of a configurable player station, and the invention is not intended to be limited to this particular example. Rather, the invention encompasses gaming systems that include any type of player stations that are reconfigurable to provide different game presentations at different times.

FIG. 3 shows a gaming system 300 embodying the principles of the invention. Gaming system 300 is divided into four separate layers of physical devices in order to better distinguish the various physical devices. A first layer 301 comprises casino floor devices and casino floor support devices. The second layer 302 of devices shown in FIG. 3 comprises casino management interface devices. Third layer 303 of devices shown in FIG. 3 is made up of management devices, and the final layer 304 of devices is made up of management clients.

The first layer 301 of devices shown in FIG. 3, the casino floor devices and casino floor support devices, include a number of configurable player stations 100 through which players may participate in games offered at a gaming facility. The first layer of devices also includes several point-of-sale terminals 302 which preferably provide an access point for sales and accounting services for players at the gaming facility. The player stations 100 and point-of-sale terminals 302 represent casino floor devices which are accessible to players at the gaming facility. It will be appreciated that the point-of-sale terminals 302 may be either attended terminals or unattended, kiosk-type terminals which are operated directly by the players. The point-of-sale terminals 302 may, for example, allow a player to obtain a player card and open a player account or purchase a voucher or other device for enabling play at one of the player stations 100. Although FIG. 3 shows only three player stations 100 and two point-of-sale terminals 302 at the gaming facility/casino, a particular gaming system according to the invention may include many player stations 100 and a large number of point-of-sale terminals 302.

The devices shown on the right hand side of the casino floor device and casino support device layer 301 shown in FIG. 3 comprise data processing systems that provide certain services for facilitating operation of the casino floor devices, the player stations 100 and the point-of-sale terminals 302. The example system shown in FIG. 3 includes a player station service computer system 306, a tournament service computer system 307, a point-of-sale service computer system 308, and a database computer system 310. FIG. 3 also shows an “other service” computer system 309 to indicate that additional services may be provided in a given gaming system embodying the principles of the invention. As will be described below with reference to FIG. 4, each of the computer systems shown in FIG. 3 comprise general-purpose processing devices that execute operational program code to implement certain controllers for controlling the operation of gaming system 300 shown in FIG. 3.

All of the various casino floor devices and casino floor support devices shown in layer 301 of FIG. 3 are shown connected for communications through a network switch 312. This network switch arrangement is shown just for purposes of illustration to indicate the capability of the various floor devices and casino support devices to communicate with each other. The invention is not limited to any particular type of communications arrangement between the various casino floor devices and casino floor support devices. Also, the invention is not limited to any particular configuration of physical computer systems for implementing the various services. For example, although separate player station service computer system 306 and tournament service computer system 307 are shown in FIG. 3, a single computer system may be programmed to implement the required player station services and tournament services as will be described further below with reference to FIG. 4.

The second layer 302 of devices shown in FIG. 3, the casino management interface devices, includes a number of interface computer systems 313-316 shown connected for communications through a network switch 318. It will also be noted that switch 318 is also configured for communication with switch 312 associated with the casino floor devices and casino floor support devices. As described above in connection with the first layer devices, the invention is not limited to any particular communications arrangement and the network switches shown in the figure are shown just to indicate that the various interface devices 313-316 may communicate with the casino floor devices and perhaps the casino floor support devices.

As with the various casino floor devices and casino floor support devices, interface computer systems 313-316 shown in FIG. 3 each include a suitable computer system which may be programmed to perform certain functions under the direction of operational program code. As will be described below in FIG. 4, the operational program code is executed to perform certain interface and control functions between the management devices layer 303 and the layer 301 of casino floor devices and casino floor support devices. It will be appreciated that although FIG. 3 shows four interface systems 313-316, more or fewer such computer systems may be included in a given implementation of the invention depending upon the number of functions to be controlled through the various interface computer systems. Also, it should be noted that some forms of the invention may include the tournament service system as an interface device at the casino/management system interface device level 302 rather than at the casino floor and floor support device level 301.

The management devices shown in FIG. 3 include a casino floor management server 320 and a casino floor management database server 321. These two servers are connected for communication through a network switch 322. Network switch 322 is shown in communication with switches or routers at the other device layers. Again, this network switching arrangement is shown just to indicate that communications are facilitated to and from the management devices 320 and 321 to devices in other layers in the system. The functions performed by management devices 320 and 321 will be described further below with reference to FIG. 4.

The management client layer 304 shown in FIG. 3 includes a number of separate casino floor management clients 325 through 328. These casino floor management clients provide operator access to the various casino floor device management services offered in gaming system 300. The casino floor management clients 325 and 326 are shown in FIG. 3 as being configured for wireless communications with a wireless switch 332. In one preferred implementation of the system, casino floor management clients 325 and 326 may comprise handheld or tablet computers that are capable of producing an operator interface for functions available in the gaming system. FIG. 3 also shows wired casino floor management clients 327 and 328 connected for communication through switch 333.

It should be noted that although FIG. 3 shows the four different levels 301, 302, 303, and 304 of devices for purposes of describing the relationship between the various devices and functions performed by the devices, the invention is by no means limited to the particular configuration of devices shown in FIG. 3. In particular, forms of the invention may implement the various device functions through a different configuration of devices. For example, all of the functions performed by the casino/management system interface devices at level 302 in FIG. 3 together with all of the functions provided by the management devices at level 303 in FIG. 3, and at least the functions of the wired casino floor management client devices 327/328 at management client level 304, may be implemented through a single data processing device. However, the arrangement of devices shown in FIG. 3 represents one preferred arrangement and provides processing capacity for managing large numbers of casino floor devices.

FIG. 4 shows the various controllers that are implemented through software instructions executed at the various computer systems shown in FIG. 3. FIG. 4 includes the same top three layers shown in FIG. 3 namely, casino floor devices and casino floor support devices at the top layer, casino/management interface devices at the middle layer, and management devices at the bottom layer of FIG. 4. In the arrangement shown in FIG. 4, player station 100 implements a client download controller 401 and a client launcher controller 402. These controllers are implemented through operational program code executed at one more processing devices at player station 100 to control certain operations at the player station. In particular, client download controller 401 provides client-side control for downloading software to the particular player station 100. Client download controller 401 cooperates with a separate download controller at the casino/management interface device level (download controller 418) as will be described below. The client launcher controller 402 controls the loading of various software components at the player station. That is, client launcher controller 402 controls the loading of software components at the player station 100 so that those components may be executed to provide various functionality at the player station. In addition to the controllers implemented at each player station, FIG. 4 shows a player station service controller 403, a tournament service controller 404, a point-of-sale service controller 405 a database controller 407, and an “other” service controller 406. These controllers may correspond to the computer systems shown in FIG. 3 at the casino floor device and casino floor support device layer 301. In particular the player station service computer system 306 may implement player station service controller 403, while tournament service computer system 307 shown in FIG. 3 may implement tournament service controller 404. Similarly the separate database computer system 310 in FIG. 3 may implement database controller 407 shown in FIG. 4 and the “other” service computer system 309 shown in FIG. 3 may implement the other service controller 406 shown in FIG. 4.

The controllers implemented at the casino/management interface device layer shown in FIG. 4 comprise several controllers for providing interface and control functions between the floor device layer 301 and casino management layer 303. In particular event controller 410 may be responsible for routing casino management system events to various subscribers that have been set up to receive information on these events. A casino management system event preferably comprises a set of information relating to some action in the casino management system or in the casino floor devices. For example, if a particular player station 100 changes from a first game presentation to a different game presentation, the player station will create a casino management system event made up of a set of information concerning the change in presentations. This set of information making up the casino management system event may identify the new game presentation and may indicate that the change in presentations has been made. The system device that creates the casino management system event communicates the event to event controller 410 which then forwards the information making up the casino management system event to other controllers in the system (subscribers) that require the information. In some preferred forms of the invention event controller 410 maintains a data table/lookup table that correlates each possible casino management system event with various subscribers that need to receive the event.

Accounting interface controller 411 provides an interface to an accounting system that may be used at the casino floor device and casino floor support device layer. This interface allows the casino management components to obtain information from the floor accounting system. In particular, accounting interface controller 411 receives queries for accounting-related data from the various management controllers (at the bottom level in FIG. 4) and converts them into a form understandable by the accounting system implemented at the casino floor device and casino floor support device level. Accounting interface controller 411 also preferably receives requested information from the accounting system and makes whatever format or other changes are required to make the accounting system information usable to the requesting management controller.

Profile controller 412 shown in FIG. 4 controls floor configuration according to the present invention. In particular, profile controller 412 communicates with the various player stations 100 to configure the various player stations to provide the desired game presentations. In one preferred implementation, profile controller 412 periodically (every fifteen seconds, for example) compares the actual status of each casino floor device with a current target status for the respective casino floor device. The actual status of a casino floor device such as a player station 100 will specify the game presentation currently operating at the player station, while the current target status for a player station will specify a game presentation that the system desires to be operating at the player station at that time. The actual and target status may match, in which case, the casino floor device continues to operate as specified by the actual status. However, if the target status does not match the actual status, profile controller issues commands to the appropriate devices to cause the status of the respective casino floor device to change to the target status. For example, if the profile controller detects that a player station 100 is not currently running the target game presentation, the profile controller will issue a command to the client launcher controller 402 to launch the desired game presentation. A number of target configurations for various casino floor devices may be thought of as a profile for the various casino floor devices. The profile controller 412 may use such a casino floor profile to obtain the current target status of each configurable player station in a casino. Information on the current status of each player station in a casino may be obtained directly from the various player stations or from a service associated with the gaming system which collects and maintains current status information for a number of different player stations. Such a service is described below as floor view controller 415.

Directory controller 413 provides a directory service for the other controllers in the system. In particular, directory service controller 413 provides an interface to a directory that is preferably stored at the database arrangement stored at data base server 321 shown in FIG. 3. This directory provides the appropriate network address for each device in the system such as system 300 shown in FIG. 3.

Optimization interface controller 414 controls the optimization of the various casino floor devices by providing the current target status for casino floor devices. This current target status information is used by profile controller 412 as described above. Optimization interface controller 414 may use any number of parameters to provide/determine the current target status of various casino floor devices. In particular, optimization interface controller 414 may employ any of the parameters or data discussed in U.S. patent application publication 2004-0229698-A1 to provide/determine the current target status of the various casino floor devices. The entire content of this publication is incorporated herein by this reference. In one preferred form of the present invention, for example, the “other” service controller 406 shown in FIG. 4 may control the collection and maintenance of player preference and player tracking data, and the casino/management interface devices may include an interface controller for providing casino management system access to the player preference and player tracking data. Optimization controller 414 may use this player preference and player tracking data to choose the most appropriate targets for the various casino floor devices. For example, the player preference and player tracking data may indicate that a large percentage of players in the casino or expected to be in the casino at a given time may prefer certain styles of games. In that case optimization controller 414 may select a stored casino floor configuration profile that ensures a large number of the desired styles of games or may generate a casino floor configuration profile to ensure player stations 100 are configured to provide the desired game styles. Also, operator overrides or manual configurations may be forced through optimization interface controller 414.

Floor view controller 415 maintains a live view of the casino floor for use by other system components. This live view is maintained in random access memory in the form of a set of data tables listing status information for each casino floor device. This live view status information is preferably received by floor view controller from event controller 410 as a subscriber to appropriate casino management system events that affect the current status of the various casino floor devices.

Translation controller 416 provides translation services for translating messages from outside the casino management system into casino management system events. For example, some casino floor devices may be unable to communicate directly with the casino management system of the present invention. In this case translation controller 416 converts some non-casino management system action to a casino management system event and forward that event on to event controller 410 so that the event controller can forward the event to the correct subscribers for the event.

Scheduler controller 417 provides scheduling services for scheduling the casino floor device profiles controlled through profile controller 412. The casino management system according to the invention may maintain a number of stored casino floor device profiles that specify configurations for various casino floor devices for certain times or certain conditions. Schedule controller 417 periodically checks the stored profiles to determine if the time and or conditions associated with any of the stored profiles are currently satisfied. If the time or conditions associated with a given stored profile are satisfied, schedule controller 417 makes the profile available to profile controller 412 as the target. Profile controller 412 may then direct the appropriate casino floor device configuration changes required to bring the actual configuration of the casino floor devices in line with the target configurations.

Download controller 418 controls the download of software from the management database (321 in FIG. 3) to the respective player stations 100 through the client download controller 401 implemented at the respective player stations.

Finally, ad manager controller 419 provides control for advertising that may be shown at the various player stations 100. In one preferred implementation of the invention, the casino management system maintains a database of advertisements associated with various times and/or conditions. Based on these times and/or conditions, ad manager controller 419 sends a communication to one or more player stations 100 (or conceivably other casino floor devices) to run a particular advertisement. In one preferred arrangement, the communication from the ad manager controller 419 specifies a universal resource locator (URL) that represents an address in the casino management system for advertisement content. The player station or player stations respond by addressing the URL to obtain the advertisement content to present (text, graphics, and/or audio) at the player station.

The controllers implemented at the management device layer shown in FIG. 4 comprise several controllers that provide mostly system operator control functions or system client access functions.

The agent management controller 429 performs the casino management system housekeeping. In particular, one preferred form of the casino management system requires all system components to register in order to operate in the system. Agent management controller 429 uses this registration information for the various system components to update the system directory with the correct network addresses, which may be IP addresses for example. This system directory is then accessed through directory controller 413.

Player station management controller 427 provides an interface to the data preferably stored at database server 321 in FIG. 3 for all of the player stations managed by the casino management system. This data includes configuration history and performance information, for example. Optimization controller 414 in particular may use this player station information in selecting the appropriate targets for use by profile controller 412.

Download management controller 425 maintains a list of games (game presentation software) that can be downloaded to player stations. This list is preferably maintained in the database server 321 shown in FIG. 3. A system operator may add to this list through the download management controller 425 in addition to remove games, and modify games.

The security management controller 430 shown in FIG. 4 maintains a set of functions or operations that system operators or system components may perform. Security management controller 430 is also responsible for enforcing these function or operation rules.

The tournament management controller 431 provides an interface through which a system operator may set up a tournament to be operated under the control of tournament service controller 404. This interface allows tournament participants to be entered, identification of player stations 100 to be converted for tournament use, and entry of various tournament parameters such as time, duration, cost, etc. Tournament service controller 404 also obtains tournament information through tournament management controller 431 as necessary to conduct the specified tournaments.

The optimization management controller 426 provides an interface to casino floor optimization information stored by the casino management system. Also, an operator may force casino floor device targets through optimization management controller and select how the casino floor devices are to be optimized under the control of optimization controller 414. Optimization controller 414 also uses optimization management controller 426 to access optimization information stored through the casino system.

Ad management controller 428 provides an interface to the advertising data stored in the casino management system preferably through database server 321 shown in FIG. 3. Operators may add advertisements, place time constraints and conditions on advertisements and otherwise modify advertisement information stored in the system. Ad manager controller 419 uses controller 428 to access this advertisement information in order to perform the desired ad control functions.

Finally, the operator interface management controller 432 shown in FIG. 4 is responsible for maintaining the various operator interface screens and dialogs that may be used in the system. In particular, operator interface management controller 432 maintains the graphic interfaces used by client devices 325, 326, 327, and 328 to access various system functions.

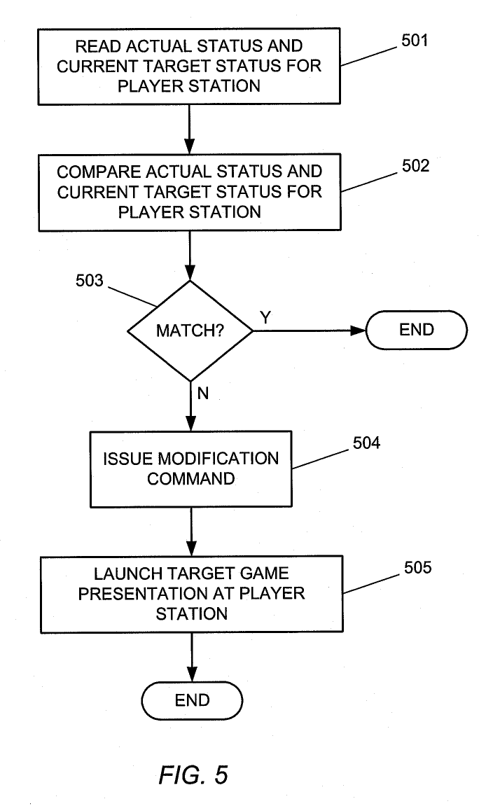

FIG. 5 provides a flow chart illustrating the operation of the profile controller 412 and the various system components that cooperate with the profile controller to control the operation of the casino floor devices, and particularly the casino player stations 100. This high level flow chart represents the process steps generally performed each time profile controller 412 checks the status for a single player station. As discussed above in connection with FIG. 4, this sequence of steps may be performed for each casino floor device periodically over a given day in order maintain a desired casino floor profile at different times of day, particularly, the desired game presentation operating at each player station being controlled through the system.

As indicated at process block 501 in FIG. 5, the process includes reading the actual status for a player station (such as player station 100 in FIGS. 1-4) and also reading of the current target status for the player station. In one preferred form of the invention the actual status for the player station is obtained from a data structure maintained by a floor view controller 415 as described above. However, the invention is not limited to any particular arrangement for obtaining the actual status for the player station 100. The current target status for the player station 100 may be obtained in a number of different fashions within the scope of the present invention. In one form of the invention, scheduler controller 417 shown in FIG. 4 determines that conditions have been met for a given stored casino floor profile, and communicates that profile to the profile controller 412. The current target status for the player station 100 is the status identified for that player station in the casino floor profile. Also, optimization controller 414 shown in FIG. 4 may select an optimum casino floor profile as described above and communicate that optimum casino floor profile to the profile controller 412 or otherwise make that profile available to profile controller. In this case, the current target status read at process block 501 in FIG. 5 comprises the status for the player station 100 specified in the casino floor profile selected by optimization controller 414.

After the actual status and current target status for the player station 100 are each read or otherwise identified as indicated at process block 501, the illustrated method includes comparing the actual status and the current target status for the player station as indicated at process block 502. The purpose of this comparison is to identify any mismatch between the actual status for the player station 100 and the current target status that has been specified for the player station at that particular time. One type of mismatch that the comparison at process block 502 may identify is a mismatch between the game presentation specified by the actual status for the player station and a target game presentation specified by the current target status for the player station. The comparison performed as indicated at process block 502 in FIG. 5 may be performed in any suitable fashion within the scope of the invention. In one preferred arrangement, both the actual status for the player station 100 and the current target status for the player station are expressed in the form of a data structure having a number of different fields which each specify some portion of the status for the player station. One field may specify the game presentation for the player station. In this arrangement, the comparison at process block 502 may be performed by comparing the two data structures or at least certain fields of the two data structures to identify differences between the two data structures.

If the comparison performed at process block 502 indicates a match between the actual status and current target status for the player station 100 as indicated by a positive outcome at decision block 503 in FIG. 5, the illustrated process simply ends with no action being taken to change the status of the respective player station. However, if there is a mismatch between the actual and current target status for the player station 100 as indicated by a negative result at decision block 503, the process continues on to process block 504. At this point, profile controller 412 issues a modification command to be communicated to the respective player station 100 in a suitable fashion. This modification command directs the player station 100 to modify its status to match the current target status compared at process block 502. In particular, if the actual status specified a first game presentation and the current target status for the player station specified a target game presentation different from the first game presentation for the comparison step at process block 502, then the modification command issued at process block 504 will specify the target game presentation and direct the respective player station 100 to switch to the target game presentation.

In the preferred form of the invention described above in connection with FIGS. 3 and 4, a client launcher controller 402 is implemented at each player station 100 and is responsible for launching a desired game presentation at the player station. In this arrangement, the modification command issued at process block 504 directs the client launcher controller 402 for the respective player station 100 to launch the target game presentation at the player station as indicated at process block 505 in FIG. 5. The process performed by profile controller 412 then ends for that particular player station and that particular time.

As indicated above, the process shown generally at FIG. 5 is performed at different times over the course of a given day for each casino floor device, and particularly for each player station 100 being controlled through the system. Although the process is described for a single player station 100 in FIG. 5 for purposes of describing the invention, the process may in fact include substantially simultaneously performing all of the steps in FIG. 5 for each player station 100. In this form of the invention, reading the actual status and current target status for each player station 100 may include reading a data structure that includes a number of entries, one entry for each player station 100. The comparison at process block 502 may be a comparison between these two data structures. Each entry in this data structure that indicates a status mismatch causes profile controller 412 to issue a respective modification command as indicated at process block 504 to the respective player station 100 identified by the entry for which the mismatch was detected.

As discussed above in connection with FIG. 4, the various controllers that are included in the present invention may comprise generally purpose processing devices operating under the control of program code to perform the various controller functions. In particular, a client launcher controller 402 for a given player station 100 may be implemented by the player station CPU, CPU 205 in FIG. 1, executing client launcher controller program code. Profile controller 412 for the invention may be implemented by casino floor management server 320 in FIG. 3 executing profile controller program code. Casino floor management server 320 in FIG. 3 may also execute optimization controller program code to implement optimization controller 414 in FIG. 4, and scheduler program code to implement scheduler controller 417 shown in FIG. 4.

Example Features of Casino Management System

I. Enhanced Player Interactivity

One form of the present invention includes an arrangement for providing greater interactivity at the various player stations 100. A method according to this form of the invention includes displaying a game presentation on a first video display device (104 in FIG. 1) associated with a player station and on a second video display device (107, 105, or 108 in FIG. 1) associated with the player station. While continuing to display the game presentation on the first video display device 104, removing at least a portion of the game presentation from the second video display device 107, 105, and/or 108 and displaying a non-game presentation on the second video display. This non-game presentation is unrelated to the game presentation. For example, the non-game presentation may include a menu for enabling a player to order a service or product. In one form of the invention a presentation controller associated with the player station causes the first video display device 104 and the second video device 107, 105, or 108 to display the game presentation and also causes at least a portion of the game presentation to be removed from the second video display device 107, 105, and/or 108 so that the non-game presentation is displayed on the second video display. This game presentation controller is preferably implemented through processor 205 of the player station.

In some forms of the invention, the change from the game presentation to the partial non-game presentation may be prompted by some action at the respective player station 100. For example, the player station 100 may include a call attendant or help control, and the presentation change may be made in response to the player activating that control. In other forms of the invention the change to display the non-game presentation at player station 100 may be prompted by a command issued by a component of the gaming system remote from the player station. For example, the gaming system may include an announcement controller as one of the casino/management interface devices located remotely from the player station 100. This announcement controller may communicate an announcement command to the player station 100 and the player station may display the non-game presentation in response to the receipt of the announcement command. Such an announcement controller might be included in the gaming system at the casino/management interface device level shown in FIGS. 3 and 4 for providing general announcements at the various player stations included in the system. Alternatively to a general purpose announcement controller, a device such as ad manager controller 419 in FIG. 4 may send an announcement command. In this case the non-game presentation will comprise a presentation relating to advertising.

II. Player Station Compatibility Verification

Some forms of the present invention implement a verification process to ensure that a given player station 100 is capable executing a given game presentation. Such a verification process may include first receiving a game presentation load request specifying a player station and also specifying a game presentation to be loaded at the player station. An identifier for the player station 100 may be used to retrieve player station attributes from a player station attribute storage device which may comprise a storage device associated with database server 321 in FIG. 3. An identifier for the game presentation to be loaded at the player station is also used to retrieve game presentation requirements from a game presentation requirement storage device which may also comprise the same or a different storage device associated with database server 321. The verification process includes comparing the player station attributes to the game presentation requirements to produce a comparison result, and then producing a game presentation download response based on the comparison result. This comparison step may be performed by player station management controller 42 in the management devices layer shown in FIG. 4. The download response may prevent the game presentation from being downloaded to the player station 100 if the game presentation is incompatible with the player station in some way and thus may not execute properly at the given player station. However, if the comparison result indicates that the player station is compatible with the game presentation, then the download response may direct the download controller 418 in FIG. 4 to download the game presentation software or other game presentation implementing information to the identified player station.

III. Simplified Manual Casino Floor Management

The present invention also facilitates manual casino floor configuration. One method according to the invention includes collecting status information from each player station included at a gaming facility and storing the collected status information in a live view data store. This information collection may be performed by floor view controller 415 shown in FIG. 4 and the data stored in fast memory associated with the processing device implementing controller 415. The method also includes communicating at least a portion of the collected status information from the live view data store to a management interface device. This management interface device may be a wireless casino floor management client such as clients 325 and 326 in FIG. 3, or one of the wired clients 327 and 328. The collected status information is then used to display a graphical representation at the management client (325, 326, 327, or 328) indicating a current status of one or more of the player stations 100 included at the gaming facility. At this point a management system operator may use the management client device to generate a management command. The gaming system may then execute the management command to affect one or more of the player stations 100 included at the gaming facility. For example, the management command may direct a respective player station 100 to change from a first game presentation to a new game presentation or to download one or more additional game presentations. Where a game presentation change is involved in the management command, the client launcher controller 402 associated with the respective player station 100 preferably causes the new game presentation to launch at the player station.

IV. Non-Disruptive Dispute Resolution

One important feature of the present game system is the ability to provide quick and non-disruptive dispute resolution on the casino floor. Dispute resolution may be performed particularly using wireless management client devices such as devices 325 and 326 in FIG. 3. Perhaps most importantly, dispute resolution may be accomplished without taking any of the player stations involved in the dispute out of service.

A method according to the invention includes collecting status information from each player station included at a gaming facility and storing the collected status information in a historical view data store. This collection of information may be performed by each respective player station 100 with the historical information stored locally at the respective player station. Regardless of specifically where the historical information is maintained in the gaming system the method includes generating a history access command at the management interface device such as one of the wireless devices 325 or 326 shown in FIG. 3. The history access command is executed by the system to cause a history of play at one or more of the player stations 100 included at the gaming facility to be displayed at the management interface device. Executing the history access command may be performed by the player station management controller 427 shown in FIG. 4 and will involve transferring historical information such as screen shots from a data storage device to the management interface device such as device 325 or 326. Of course the dispute resolution may also be performed using a wired management device such as device 327 or 328.

V. Tournament Control

The present invention also facilitates temporary tournament play at player stations that typically operate in normal revenue generating mode. A tournament implementing method according to the invention includes operating a number of player stations 100 at a gaming site in a standard mode in which a game presentation is displayed at the player station. A number of tournament players are enrolled in a gaming tournament to be conducted at a predetermined time through the number of player stations 100. A tournament command is communicated to each of the number of player stations to be used in the tournament, and, in response to the tournament command received at each player station, each respective player station converts to a tournament mode in which a portion of the game presentation is replaced with a tournament presentation. For example, the normal top glass display for the game presentation provided through display device 107 may be changed to show tournament information such as the respective player's rank in the tournament and other tournament specific information. Regardless of the specific nature of the tournament presentation, the player stations are operated in the tournament mode for a tournament period. After the tournament period, the player stations may be returned to the standard mode of operation, preferably automatically. Two or more player stations may also be grouped to provide team play in the tournament.

In preferred implementations of the gaming system, a tournament service controller such as controller 404 in FIG. 4 manages all tournament play. This controller manages enrollment data, and tournament configuration. The tournament service controller 404 also preferably maintains tournament data during the course of the tournament and supplies that data to the various player stations operating in tournament mode so that the tournament information may be displayed at the player station. During a preliminary or setup period, controller 404 may direct the various player stations operating in tournament mode to display the name of an enrolled tournament player who is to use that particular player station.

VI. Access to Casino Floor System Data

By providing interfaces between the casino management system and casino floor support systems and devices, the present invention also facilitates better usage of collected information. For example, one method according to the invention includes opening a player account for a player in a gaming system and scanning a photo ID of the player in connection with opening the player account for the player. All of the information relating to the player account may be stored through a dedicated accounting database using database controller 407 shown in FIG. 4. When the player logs in at a player station in the system, a copy of the photo from the photo ID of the player is displayed at the player station. The data for the photo is accessible in the player account data similarly to other data such as account balance, and other player identification information.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The above described preferred embodiments are intended to illustrate the principles of the invention, but not to limit the scope of the invention. Various other embodiments and modifications to these preferred embodiments may be made by those skilled in the art without departing from the scope of the following claims.

1. A method including:
(a) periodically over a given day comparing an actual status for a casino player station with a current target status for the casino player station, the actual status specifying an actual game presentation operating at the casino player station;
(b) issuing a modification command to the casino player station in the event that the current target status for the casino player station does not match the actual status for the casino player station; and
(c) in response to the modification command, launching a target game presentation at the casino player station, the target game presentation being specified by the current target status for the casino player station and being different from the actual game presentation specified by the actual status for the casino player station.

2. The method of claim 1 further including:
(a) for each one of a number of additional casino player stations, periodically over a given day comparing an actual status for the respective additional casino player station with a current target status for the respective additional casino player station;
(b) issuing a respective modification command to each respective additional casino player station for which the current target status for the respective additional casino player station does not match the actual status for the respective additional casino player station; and
(c) in response to the respective modification command, launching a respective target game presentation at the respective additional casino player station, the respective target game presentation being specified by the current target status for the respective additional casino player station and being different from a respective actual game presentation specified by the actual status for the respective additional casino player station.

3. The method of claim 1 further including reading the current target status for the casino player station from a casino floor profile which includes a respective current target status for a number of additional casino player stations in addition to the current target status for the casino player station.

4. The method of claim 3 further including selecting the casino floor profile from a number of casino floor profiles stored in a data storage device.

5. The method of claim 3 wherein the casino floor profile is associated with a number of conditions and further including determining that the conditions are met prior to reading the current target status for the casino player station from the casino floor profile.

6. The method of claim 1 further including reading the actual status for the casino player station from a data structure representing a live view of a casino floor in which the casino player station is included, the data structure being stored remotely from the casino player station.

7. The method of claim 1 wherein the step of periodically comparing the actual status for the casino player station and the current target status for the casino player station is performed in response to the passage of a predetermined period of time after a previous comparison of a then actual status for the casino player station and a then current target status for the casino player station.

8. An apparatus for controlling the game presentations available at the player stations of a casino, the apparatus including:
(a) a profile controller for periodically over a given day comparing an actual status for a first player station with a current target status for the first player station, and for issuing a modification command to the first player station in the event that the current target status for the first player station does not match the actual status for the player first station, the actual status for the first player station specifying an actual game presentation operating at the first player station; and
(b) a client launcher controller for causing the first player station to launch a target game presentation in response to the modification command, the target game presentation being specified by the current target status for the first player station and being different from the actual game presentation specified by the actual status for the first player station.

9. The apparatus of claim 8 wherein:
(a) the casino includes a number of additional player stations in addition to the first player station;
(b) for each additional player station, the profile controller is also for periodically over a given day comparing an actual status for the respective additional player station with a current target status for the respective additional player station, and for issuing a respective modification command to each respective additional player station for which the current target status for the respective additional player station does not match the actual status for the respective additional player station; and
(c) a respective client launcher controller for each respective additional player station is for launching a respective target game presentation at the respective additional player station, the respective target game presentation being specified by the current target status for the respective additional player station and being different from a respective actual game presentation specified by the actual status for the respective additional player station.

10. The apparatus of claim 8 wherein the profile controller is also for reading the current target status for the first player station from a casino floor profile which includes a respective current target status for a number of additional player stations in addition to the current target status for the first player station.

11. The apparatus of claim 10 further including an optimization controller for selecting the casino floor profile from a number of casino floor profiles stored in a data storage device.

12. The apparatus of claim 10 wherein the casino floor profile is associated with a number of conditions and further including a scheduler controller for determining that the conditions are met prior to making the casino floor profile available to the profile controller for reading the current target status for the first player station from the casino floor profile.

13. The apparatus of claim 8 wherein the profile controller reads the actual status for the first player station from a data structure representing a live view of a casino floor in which the first player station is included, the data structure being stored at a storage device remote from the first player station.

14. The apparatus of claim 8 wherein the profile controller compares the actual status for the first player station and the current target status for the first player station in response to the passage of a predetermined period of time after a previous comparison of a then actual status for the first player station and a then current target status for the first player station.

15. A program product embodied in one or more computer readable media, the program product being executable for controlling the game presentations available at the various player stations of a casino and including:
(a) profile controller program code executable for periodically over a given day comparing an actual status for a first player station with a current target status for the first player station, and for issuing a modification command to the first player station in the event that the current target status for the first player station does not match the actual status for the player first station, the actual status for the first player station specifying an actual game presentation operating at the first player station; and
(b) client launcher controller program code for causing the first player station to launch a target game presentation in response to the modification command, the target game presentation being specified by the current target status for the first player station and being different from the actual game presentation specified by the actual status for the first player station.

16. The program product of claim 15 wherein the profile controller program code is also executable for reading the current target status for the first player station from a casino floor profile which includes a respective current target status for a number of additional player stations in addition to the current target status for the first player station.

17. The program product of claim 16 further including optimization controller program code executable for selecting the casino floor profile from a number of casino floor profiles stored in a data storage device.

18. The program product of claim 16 wherein the casino floor profile is associated with a number of conditions and further including scheduler controller program code executable for determining that the conditions are met prior to making the casino floor profile available to the profile controller program code for reading the current target status for the first player station from the casino floor profile.

19. The program product of claim 15 wherein the profile controller program code is also executable to read the actual status for the first player station from a data structure representing a live view of a casino floor in which the first player station is included.

20. The program product of claim 15 wherein the profile controller program code is executable for detecting the passage of a predetermined period of time after a previous comparison of a then actual status for the first player station and a then current target status for the first player station and for comparing the actual status for the first player station and the current target status for the first player station in response to the passage of the predetermined period of time.
